(19) United States
(12) Patent Application Publication
(10) Pub. No.: US 2011/0089201 A1
(43) Pub. Date: Apr. 21, 2011

(54) Apparatus for collecting, storing and discharging a granular matter

(76) Inventor: Henrik Pape, Horsens (DK)

(21) Appl. No.: 12/589,170

(22) Filed: Oct. 19, 2009

(51) Int. Cl. G01F 11/20

(52) U.S. Cl. 222/412

(57) ABSTRACT

Apparatus for collecting, storing and discharging a granular matter comprising, an upper end with an inlet opening for receiving the granular matter, a lower end with a collection zone, opposite side walls, which are inwardly inclining from the upper end towards the lower end, opposite end walls, where one end wall has a discharge opening, and a transport device located in the collection zone, for transporting the granular matter through the discharge opening, wherein the side walls are inclined at different angles.

### FIELD OF THE INVENTION

The present invention relates to an apparatus for collecting, storing and discharging a granular matter.

### INTRODUCTION

Apparatus for collecting, storing and discharging a granular matter may be used in machines where the granular matter is provided by process equipment inside or upstream from the machine.

The granular matter is collected and stored in a hopper before being discharged to further processing or distribution. The hopper may be funnel shaped. A transport device is located at the bottom of the hopper to discharge the granular matter through an exit opening in the end wall of the hopper.

A problem with such a device is known as “bridging”, where the granular matter forms a bridge above the transport device. This effectively precludes further discharge of material through the exit opening.

An attempt to solve this in the art has been by providing a stirrer for preventing the granular matter in forming a bridge.

A further attempt to solve the problem of bridging is provided with U.S. Pat. No. 4,056,215, which discloses an anti-bridging device for a hopper. The anti-bridging device comprises at least one anti-bridging member which is movably attached to one side wall of the hopper with cooperating elements to raise and lower the anti-bridging member. The cooperating elements for raising and lowering the anti-bridging member are generally upwardly extending members on the transport device which contacts the anti-bridging member during movement of the transport devise. This causes the anti-bridging member to sweep the side wall to which it is attached to preclude the built up of a bridge across the transport devise.

The relative movement and contract between the various parts of the anti-bridging element, the cooperating elements, the side walls and the upwardly extending members may give rise to wear, such that frequent maintenance is required.

### SUMMARY OF THE INVENTION

It is an object of the present invention to provide an apparatus for collecting, storing and discharging a granular matter in which simple means for reducing bridging is provided.

In one embodiment, an apparatus for collecting, storing and discharging a granular matter is provided, which comprises, an upper end with an inlet opening for receiving the granular matter, a lower end with a collection zone, opposite side walls, which are inwardly inclining from the upper end towards the lower end, opposite end walls, where one end wall has a discharge opening, and a transport device located in the collection zone, for transporting the granular matter through the discharge opening, wherein the side walls are inclined at different angles.

The different angles of the side walls establish an asymmetry in the hopper shaped structure defined by the side and end walls. This asymmetry has been found to reduce the occurrence of bridging, thus avoiding the need for auxiliary means for preventing bridge formations in the granular matter

Other features and advantages of the present invention will become more readily apparent to those of ordinary skill in the art after reviewing the following detailed description and accompanying drawings.

### BRIEF DESCRIPTION OF THE DRAWING

The invention will be explained in more detail below with reference to the accompanying drawings, in which identical or corresponding elements will be provided with the same designations in different figures, where:

FIG. 1 is a perspective view of a first embodiment of an apparatus for collecting, storing and discharging a granular matter,

FIG. 2 is a plan view of the apparatus of FIG. 1,

FIG. 3 is a section view through the apparatus of FIG. 1 on lines A-A in FIG. 2,

FIG. 4 is a plan view of a second embodiment of an apparatus for collecting, storing and discharging a granular matter,

FIG. 5 is a section view through the apparatus of FIG. 4 on lines B-B.

### DETAILED DESCRIPTION OF THE INVENTION

After reading this description it will become apparent to one skilled in the art how to implement the invention in various alternative embodiments and alternative applications. However, it is understood that the embodiments are presented by way of example only and not a limitation. As such the detailed description should not be construed to limit the scope or breadth of the present invention.

In the following description the term “granular matter” is used for discrete units of material of any shape such as; cube-like shapes, oval shapes, crushed material, flakes, chips and the like. An example of such a granular material for which the embodiments described herein is especially suited is ice or ice cubes with shapes as described above.

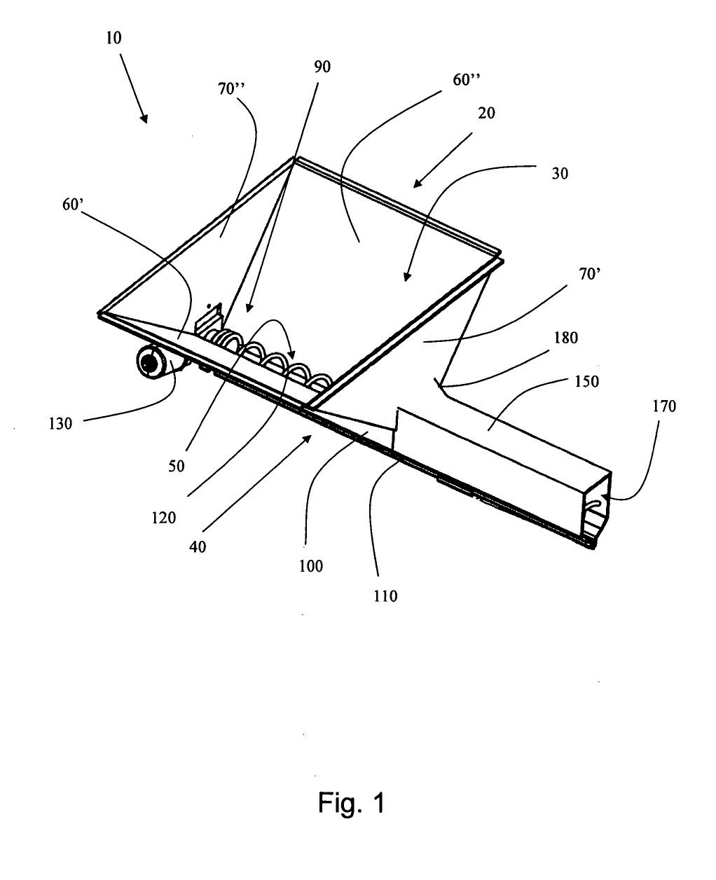

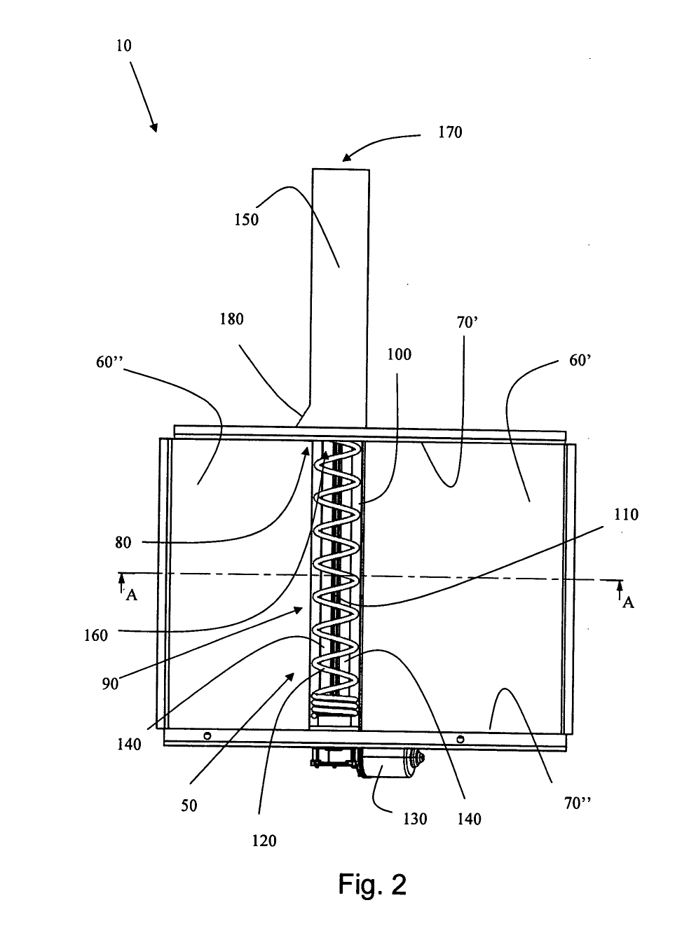

FIGS. 1-3 illustrates a first embodiment of the apparatus 10 for collecting, storing and discharging a granular matter.

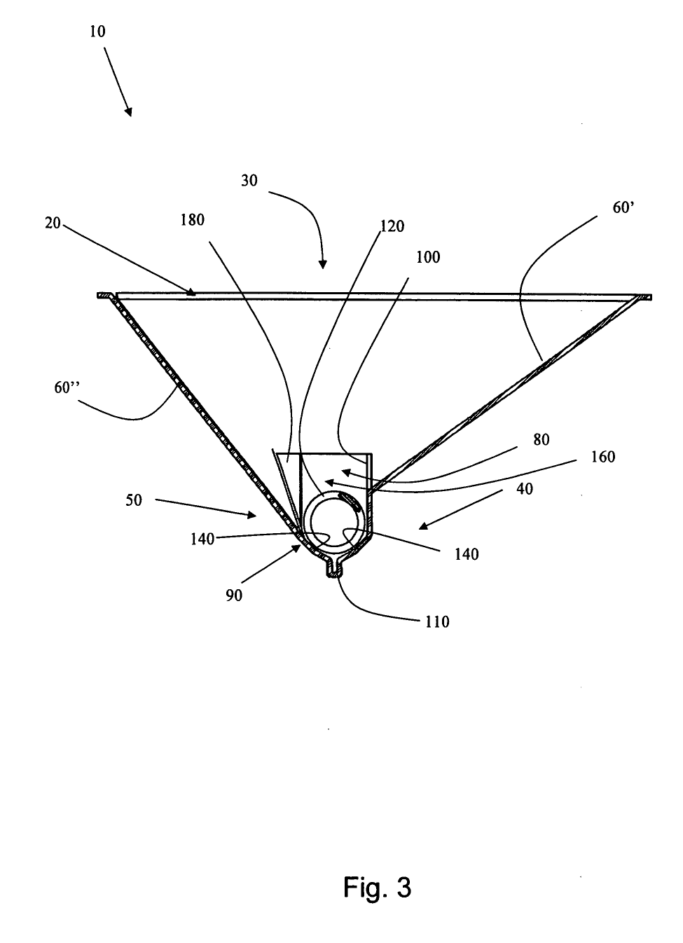

The apparatus 10 has an upper end 20 with an inlet opening 30 for receiving the granular matter and a lower end 40 with a collection zone 50. A hopper shaped structure, such that the collection zone 50 may be completely emptied, is formed by opposite side walls 60′, 60″, which are inwardly inclining from the upper end 20 towards the lower end 40 and opposite end walls 70′, 70″. One end wall 70′ has a discharge opening 80 (see FIG. 3) for the granular matter.

A transport device 90′ is located in the collection zone 50, for transporting the granular matter through the discharge opening 80 (see FIG. 3). The transport device 90′ is directed substantially parallel to the side walls 60′, 60″ and substantially perpendicular to the end walls 70′, 70″.

The side walls 60′, 60″ are inclined at different angles, such that an asymmetry is established in the hopper shaped structure. This asymmetry has been found to reduce the occurrence of bridging, thus avoiding the need for auxiliary means for preventing bridge formations in the granular matter. The apparatus 10 hereby cancel the need to maintain such auxiliary means.

A collection zone side wall 100 is provided between the lower end 40 and one of the side walls 60′, 60″. In the embodiment shown in FIG. 1-3 the collection zone side wall is provided at the less steep side wall 60′. The collection zone side wall is substantially vertical. This further adds to the asymmetry of the hopper shaped structure.

In the embodiment on FIGS. 1-3, which has been developed by the inventor for collecting, storing and discharging ice and ice cubes, the angle to the vertical of the steeper side wall 60″ is around 38 degrees and around 54 degrees for the other side wall 60′. This should not be construed as limiting; other angles may be selected for other applications dependent on the properties of the granular matter.

A drain channel 110 is extending under the collection zone to collect condensate or melted liquid. The drain channel 110 is formed as a trough (see FIG. 3) with the opening facing towards the collection zone 100. The drain channel 110 may be inclined, such that the liquid collects at one collection point along or at one end of the drain channel 110. The liquid is removed from the drain channel 110 in any suitable manner available to the skilled person.

In an alternative embodiment the drain channel 110 may be provided with openings along its length for drainage into an external drip pan (not shown).

The transport device 90 is a center less helical drive spring 120 rotatably driven by a motor 130. The drive spring 120 will be easy to clean. Moreover the drive spring 120 is manufactured from one thread with no welds and no joints. The surface of the drive spring 120 will be smooth. These features help reducing bacteria build up and makes it easier to clean the drive spring 120.

In embodiments, such as the first embodiment, where the collection zone side wall 100 is placed on the right side of the drive spring 120 as viewed towards the direction of transport of the granular matter, the drive spring is preferably left-handed (see FIG. 1-3).

Bearing surfaces 140 (see FIG. 3) formed in the collection zone 50 supports the drive spring 120. The bearing surface 140 is formed on each side of a centerline through the drive spring 120. The drive spring 120 which may be flexible is therefore kept straight or in a longitudinal shape as needed to follow the bottom of the collection zone 50.

The bearing surfaces 140 are inwardly inclining towards the lower end 40, such that condensate or melted liquid is directed towards the drain channel 110 aided by gravity. The drive spring 110 tends to transport condensate or melted liquid forward, where the drive spring 110 is resting on the bearing surface 140. The inclination of the bearing surface 140 aids the removal of the condensate or melted liquid before it would otherwise exit through the discharge opening 80.

A chute 150 with an inlet 160, which is operationally connected to the discharge opening 80, and an exit 170, which is opposite the inlet 160, is extending from the end wall 70′ of the apparatus 10. The inlet 160 has a height such that it will accept units of granular matter which extend outside the drive spring.

The exit 170 is positioned above a point, where it is desired to discharge the granular matter. An example of such a point is inside a processing machine for bagging the granular matter, such as an ice bagging machine.

The chute 150 may be installed inside the processing machine such that it is horizontal, upwardly or downwardly inclined.

The drive spring 120 extends through the discharge opening 80 of the hopper shaped structure and terminates near the exit 170 end, such that the transport of the granular matter is aided through the chute 150. In installations where the chute 150 is horizontal or upwardly directed the granular matter is pushed forward by the drive spring 120, conversely the drive spring 120 will hold back the granular matter in installations where the chute 150 is downwardly inclined. In the latter case the transport of the granular matter is aided by gravity.

The inlet 160 comprises an oblique guide surface 180, such that a unit of granular matter, which is half way outside the drive spring, is gradually moved inside the drive spring. In other words the guide surface 180 is providing a funnel.

In embodiments with a collection zone side wall 100, the guide surface 180 is provided on the opposite side of the inlet 160.

As it occurs from FIGS. 1 and 3 the drain channel further extends under the chute 150.

In an alternative embodiment drainage is provided by one or more drain holes along the bottom of the collection zone 50.

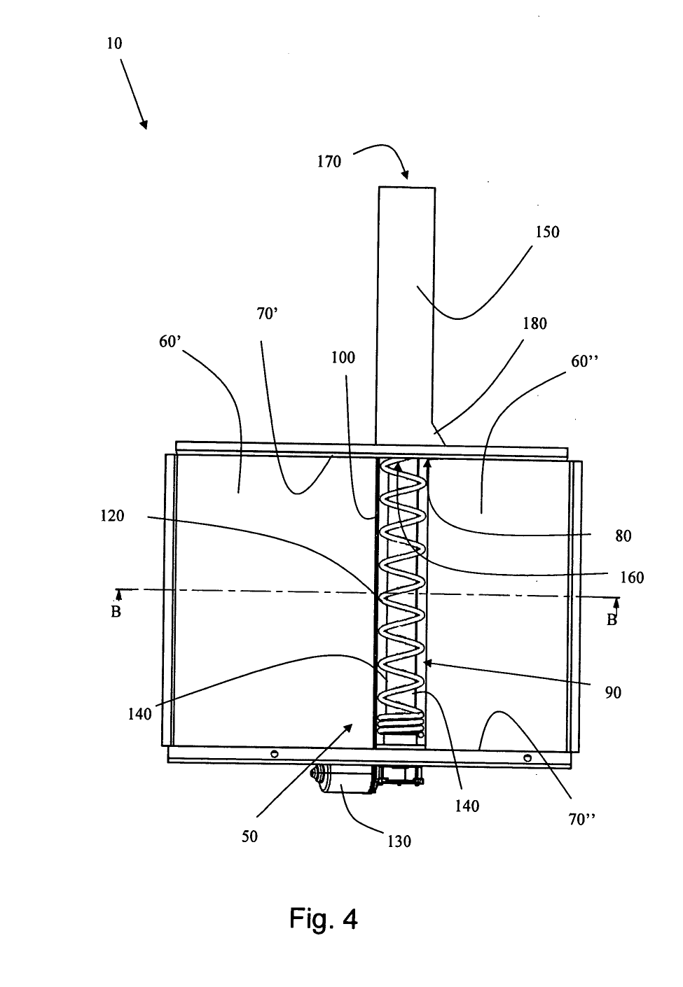

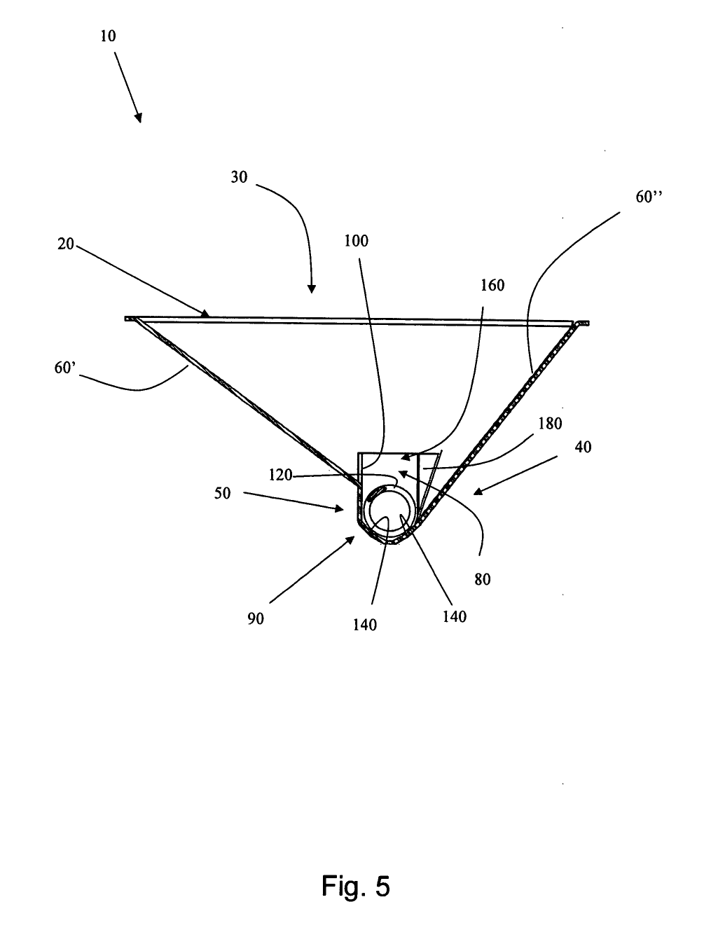

FIGS. 4-5 describes a second embodiment which is in essence the same as the first embodiment illustrated in FIGS. 1-3, therefore only the differences will be described here.

The second embodiment differs from the first embodiment in that;
the steeper side wall 60″ is positioned to the right of the drive spring 120 as viewed towards the direction of transport of the granular matter,
the collection zone side wall 100 is positioned to the right of the drive spring 120 as viewed towards the direction of transport of the granular matter,
the guide surface 180 is positioned to the right of the drive spring as viewed towards the direction of transport of the granular matter, and
the drain channel 80 (see FIG. 1-3) is not present.

The second embodiment is preferred when condensate and melted liquid is not present. The absence of a drain channel 80 (see FIG. 1-3) avoids residue from the granular matter to build up in the drain channel 80 (see FIG. 1-3). Such residue would be flushed by the condensate or melted liquid flowing in the drain channel 80 (see FIG. 1-3) in the first embodiment (see FIG. 1-3).

In embodiments, such as the second embodiment, where the collection zone side wall 100 is placed on the left side of the drive spring 120 as viewed towards the direction of transport of the granular matter, the drive spring is preferably right-handed (see FIG. 4-5).

In use the apparatus 10 is provided with the granular matter through the inlet opening 30. The granular matter collects in the collection zone 50. Upon operation of the transport device 90 the granular matter is moved towards the discharge opening 80. At the discharge opening 80 the granular matter enters the chute 150 and continues through the chute 150 until it reaches the exit 130 of the chute 150, where it exits the apparatus 10. The inwardly inclining side walls 60′, 60″, the lay-out of the collection zone 50 and the transportation device 90 ensures that the apparatus 10 may be completely emptied.

The granular matter may be supplied continuously or intermittently, and the transportation device 90 may be operated continuously or intermittently. It is therefore possible to operate the apparatus 10, such that the granular matter is taken away be the transport device immediately and does not build up inside the hopper shaped structure. In this case bridging is unlikely to occur.

When the supply of granular matter exceeds the capacity of the transportation device 90, the granular matter starts building up inside the hopper shaped structure. In this case the apparatus 10 reduce the occurrence of bridging through the asymmetrical features of the design.

The different angles of the side walls 60′, 60″ help to allow the granular matter to rotate in a circular motion and topple inwardly towards the collection zone 50 at the lower end 40. The granular matter is then taken up by the drive spring 120 when space is available within the drive spring 120 and taken towards the discharge opening 80.

Bigger lumps of multiple discrete units of granular matter, such as ice cubes sticking together, may be formed. The drive spring 120 is able to crush such lumps. The lump is pinned between a turn of the helical drive spring 120 and the end wall 70′ at the discharge opening 80. The motor 130 builds up energy in the drive spring 120, by deforming it axially and radially until the energy stored in the drive spring 120 reaches a level which is sufficiently high to separate the lump into the original discrete units or smaller crushed pieces, which are able to exit through the discharge opening 80.

The build up of torque in the motor 130 for a helical drive spring 120 is gradual in contrast to a screw drive or an auger, where the torque built up is near instant, such that the motor will switch off. This is because a screw drive is generally rigid. Therefore units or lumps of granular matter, which become pinned between a turn of the screw drive and the end wall 70′, may result in jamming of the screw drive.

After the discharge opening 80 and during entering the inlet 160 of the chute 150 the granular matter is gently pressed inside the volume of the drive spring 120 by the guide surface 180. Units of granular matter larger than normal or lumps, which are not sufficiently crushed to fit within the volume of the drive spring 120, can utilize the free space in the chute 150 above the drive spring 120.

The granular matter is transported through the chute 150 by the drive spring 120. The chute may be used as a drying channel, where condensate or melted liquid is from the granular matter is urged towards the drain channel assisted by the drive spring.

Upon reaching the end of the chute 150 the granular matter leaves the chute 150 through the exit 170 for further processing.

In one embodiment, the apparatus described herein is used in the system described in U.S. patent application Ser. No. 12/449,132, which is hereby incorporated by reference. For example, the apparatus described herein can be substituted for the funnel shaped part 131 and the U-shaped channel 132 shown in FIG. 7 of that application.

1. Apparatus for collecting, storing and discharging a granular matter comprising, an upper end with an inlet opening for receiving the granular matter, a lower end with a collection zone, opposite side walls, which are inwardly inclining from the upper end towards the lower end, opposite end walls, where one end wall has a discharge opening, and a transport device located in the collection zone, for transporting the granular matter through the discharge opening, wherein the side walls are inclined at different angles.

2. The apparatus of claim 1 further comprising a collection zone side wall, which is located between the lower end and one of the opposite side walls, said collection zone side wall being substantially vertical.

3. The apparatus of claim 1 further comprising a drain channel extending under the collection zone.

4. The apparatus of claim 1 wherein the transport device comprises a center less helical drive spring and a motor, where the drive spring is rotatably driven by said motor.

5. The apparatus of claim 4 wherein a bearing surface is formed in the collection zone on each side of a centerline through the drive spring, for supporting said drive spring.

6. The apparatus of claim 5 wherein the bearing surface is inwardly inclining towards the lower end.

7. The apparatus of claim 1 further comprising a chute with an inlet, which is operationally connected to the discharge opening, and an exit, which is opposite the inlet.

8. The apparatus of claim 7 wherein the transport device extends through the discharge opening and is terminated near the exit end.

9. The apparatus of claim 7, wherein the inlet comprise an oblique guide surface.

10. The apparatus of claims 3 and 7 wherein the drain channel further extends under the chute.
